(19) United States
(12) Patent Application Publication
(10) Pub. No.: US 2015/0094414 A1
(43) Pub. Date: Apr. 2, 2015

(54) Thermoplastic Resin Composition and Molded Article Including the Same

(71) Applicant: Samsung SDI Co., Ltd., Yongin-si (KR)

(72) Inventors: Jo Won LEE, Uiwang-si (KR); Dong Min PARK, Uiwang-si (KR); Seung Shik SHIN, Uiwang-si (KR); Kyuong Sik CHIN, Uiwang-si (KR)

(21) Appl. No.: 14/497,860

(22) Filed: Sep. 26, 2014

(30) Foreign Application Priority Data
Oct. 1, 2013 (KR) 10-2013-0117402

(51) Int. Cl. C08L 71/12

(52) U.S. Cl. CPC C08L 71/123
USPC 524/504

(57) ABSTRACT

A thermoplastic resin composition includes: a base resin including a polyarylene ether resin and an aromatic vinyl polymer; a flame retardant; and an impact modifier, wherein the impact modifier is a rubber-modified vinyl graft copolymer in which an unsaturated monomer including about 95 wt % to about 99 wt % of an aromatic vinyl compound and about 1 wt % to about 5 wt % of a vinyl cyanide compound is grafted to a rubbery polymer; the base resin and the flame retardant form a continuous phase; and the impact modifier forms a dispersed phase. The thermoplastic resin composition can have excellent properties in terms of impact resistance, flame retardancy, and balance therebetween.

### CROSS-REFERENCE TO RELATED APPLICATION

This application claims priority under 35 USC Section 119 to and the benefit of Korean Patent Application No. 10-2013-0117402, filed Oct. 1, 2013, the entire disclosure of which is incorporated herein by reference.

### FIELD OF THE INVENTION

The present invention relates to a thermoplastic resin composition and a molded article including the same.

### BACKGROUND

A polyphenylene ether (PPE or polyphenylene oxide) resin exhibits excellent heat resistance, mechanical strength, dimensional stability upon processing, and the like. However, there is a drawback in that it is difficult to process the polyphenylene ether resin alone. The polyphenylene ether resin can be blended with an aromatic vinyl polymer, such as a polystyrene resin and the like, which exhibits excellent compatibility, and the blend can be used for interior and exterior materials of electronic products, and the like.

Although the aromatic vinyl polymer exhibits excellent processability and mechanical properties, the aromatic vinyl polymer is prone to combustion and thus exhibits poor resistance to fire. Thus, when the polyphenylene ether resin is blended with a styrene resin, a flame retardant may be added. U.S. Pat. No. 3,639,506, U.S. Pat. No. 3,883,613 and the like disclose use of polyphenylene ether resins together with a styrene resin and a flame retardant such as aromatic phosphoric acid esters and the like.

Moreover, when the aromatic vinyl polymer is blended with the polyphenylene ether resin, an overall resin composition can exhibit deteriorated impact strength. To overcome such drawbacks, an impact modifier may be added together with the flame retardant when the aromatic vinyl polymer is blended with the polyphenylene ether resin. However, increasing the amount of the impact modifier, such as a rubber-modified graft resin including g-ABS, inorganic fillers, and the like, can cause deterioration in flame retardancy of the overall resin composition.

Therefore, there is a need for a resin composition which has excellent flame retardancy, impact strength, and balance therebetween even when the resin composition includes all of the polyphenylene ether resin, the aromatic vinyl polymer, the flame retardant, and the impact modifier.

### SUMMARY

The present invention can provide a thermoplastic resin composition that can have excellent flame retardancy, impact strength and balance therebetween and includes an impact modifier exhibiting excellent dispersibility, and a molded article including the same.

The thermoplastic resin composition includes: a base resin including a polyarylene ether resin and an aromatic vinyl polymer; a flame retardant; and an impact modifier, wherein the impact modifier is a rubber-modified vinyl graft copolymer in which an unsaturated monomer including about 95% by weight (wt %) to about 99 wt % of an aromatic vinyl compound and about 1 wt % to about 5 wt % of a vinyl cyanide compound is grafted to a rubbery polymer; the base resin and the flame retardant form a continuous phase; and the impact modifier forms a dispersed phase.

In one embodiment, the base resin may include about 30 wt % to about 70 wt % of the polyarylene ether resin and about 30 wt % to about 70 wt % of the aromatic vinyl polymer.

In one embodiment, the flame retardant may be present in an amount of about 5 parts by weight to about 30 parts by weight, and the impact modifier may be present in an amount of about 12 parts by weight to about 18 parts by weight, each based on about 100 parts by weight of the base resin.

In one embodiment, the polyarylene ether resin may be a polymer including a repeat unit represented by Formula 1:

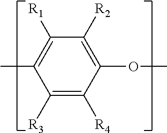

wherein R₁, R₂, R₃ and R₄ are the same or different and are each independently a hydrogen atom, a halogen atom, C₁ to C₆ alkyl, or C₆ to C₁₂ aryl.

In one embodiment, the aromatic vinyl polymer may include at least one of polystyrene, poly(α-methylstyrene), poly(β-methylstyrene), and/or polyvinyl naphthalene.

In one embodiment, the polyarylene ether resin may have a weight average molecular weight from about 10,000 g/mol to about 200,000 g/mol, and the aromatic vinyl polymer may have a weight average molecular weight from about 20,000 g/mol to about 500,000 g/mol.

In one embodiment, the thermoplastic resin composition may have an Izod impact strength from about 7 kgf·cm/cm to about 20 kgf·cm/cm, as measured on an about ⅛″ thick specimen in accordance with ASTM D638.

In one embodiment, the thermoplastic resin composition may have a flame retardancy level of V0 or higher, as measured on an about 2.5 mm thick specimen according to the UL-94 vertical flammability test method.

Exemplary embodiments of the present invention also relate to a molded article formed of the thermoplastic resin composition as set forth above.

### BRIEF DESCRIPTION OF THE DRAWINGS

FIG. 1 is a transmission electron microscope (TEM) image of a specimen prepared in Example 1.

FIG. 2 is a TEM image of a specimen prepared in Comparative Example 1.

FIG. 3 is a TEM image of a specimen prepared in Comparative Example 2.

### DETAILED DESCRIPTION

Exemplary embodiments now will be described more fully hereinafter in the following detailed description, in which some, but not all, embodiments of the invention are described. Indeed, this invention may be embodied in many different forms and should not be construed as limited to the embodiments set forth herein; rather, these embodiments are provided so that this disclosure will satisfy applicable legal requirements.

In accordance with exemplary embodiments of the present invention, a thermoplastic resin composition includes: a base resin including a polyarylene ether resin and an aromatic vinyl polymer; a flame retardant; and an impact modifier, wherein the base resin and the flame retardant form a continuous phase, and the impact modifier forms a dispersed phase.

According to the present invention, the polyarylene ether resin may include, for example, a polymer including a repeating unit represented by Formula 1:

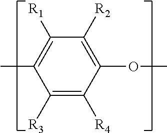

wherein R₁, R₂, R₃ and R₄ are the same or different and are each independently a hydrogen atom, a halogen atom, C₁ to C₆ alkyl, or C₆ to C₁₂ aryl.

Examples of the polyarylene ether resin may include without limitation poly(1,4-phenylene ether), poly(1,3-phenylene ether), poly(1,2-phenylene ether), poly(2-methyl-1,4-phenylene ether), poly(3-methyl-1,4-phenylene ether), poly(2-methyl-1,3-phenylene ether), poly(4-methyl-1,3-phenylene ether), poly(5-methyl-1,3-phenylene ether), poly(6-methyl-1,3-phenylene ether), poly(3-methyl-1,2-phenylene ether), poly(4-methyl-1,2-phenylene ether), poly(5-methyl-1,2-phenylene ether), poly(6-methyl-1,2-phenylene ether), poly(2,4-dimethyl-1,4-phenylene ether), poly(2,6-dimethyl-1,4-phenylene ether), poly(2,6-diethyl-1,4-phenylene ether), poly(2,6-dipropyl-1,4-phenylene ether), poly(2-methyl-6-ethyl-1,4-phenylene ether), poly(2-methyl-6-propyl-1,4-phenylene ether), poly(2-ethyl-6-propyl-1,4-phenylene ether), poly(2,6-diphenyl-1,4-phenylene ether), a copolymer of poly(2,6-dimethyl-1,4-phenylene ether) and poly(2,3,6-trimethyl-1,4-phenylene ether), a copolymer of poly(2,6-dimethyl-1,4-phenylene ether) and poly(2,3,5-triethyl-1,4-phenylene ether), and the like, and combinations thereof In exemplary embodiments, the polyarylene ether resin may be poly(1,4-phenylene ether), poly(2,4-dimethyl-1,4-phenylene ether), and the like.

The polyarylene ether resin may have a weight average molecular weight (Mw) from about 10,000 g/mol to about 200,000 g/mol, for example, from about 15,000 g/mol to about 50,000 g/mol, as measured by gel permeation chromatography (GPC). In addition, the polyarylene ether resin may have an intrinsic viscosity (IV) from about 10 dL/g to about 100 dL/g, for example, from about 30 dL/g to about 50 dL/g, as measured at about 25° C. using an Ubbelohde viscometer after the polyarylene ether resin is dissolved in a sulfuric acid solution (about 98%). Within these ranges of weight average molecular weight and intrinsic viscosity, the impact modifier can be easily dispersed and the resin composition can have excellent flame retardancy, impact strength and balance therebetween.

In one embodiment, the base resin may include the polyarylene ether resin in an amount of about 30 wt % to about 70 wt %, for example, about 40 wt % to about 60 wt %, based on the total weight (100 wt %) of the base resin including the polyarylene ether resin and the aromatic vinyl polymer. In some embodiments, the base resin may include the polyarylene ether resin in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of polyarylene ether resin can be in a range from about any of the foregoing amounts to about any other of the foregoing amounts.

Within this range, the impact modifier can be easily dispersed and the resin composition can have excellent flame retardancy, impact strength and balance therebetween.

According to the present invention, the aromatic vinyl polymer may be a polymer including one or more of an aromatic vinyl monomer. Examples of the aromatic vinyl monomer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and combinations thereof. In exemplary embodiments, the aromatic vinyl monomer may be styrene.

Examples of the aromatic vinyl polymer may include without limitation polystyrene (PS), poly(α-methylstyrene), poly(β-methylstyrene), polyvinyl naphthalene, and the like. These may be used alone or in combination thereof In exemplary embodiments, the aromatic vinyl polymer may be polystyrene.

Methods of preparing the aromatic vinyl polymer are well known to those of ordinary skill in the art, and the aromatic vinyl polymer is commercially available. For example, the aromatic vinyl polymer may be polymerized by thermal polymerization without an initiator, or may be polymerized in the presence of an initiator. The initiator may include peroxide initiators such as benzoyl peroxide, t-butyl hydroperoxide, acetyl peroxide, cumene hydroperoxide and the like; and azo initiators such as azobisisobutyronitrile, without being limited thereto.

The aromatic vinyl polymer may be prepared by bulk polymerization, suspension polymerization, emulsion polymerization, or a combination thereof In exemplary embodiments, the aromatic vinyl polymer is prepared by bulk polymerization.

The aromatic vinyl polymer may have a weight average molecular weight from about 20,000 g/mol to about 500,000 g/mol, for example, from about 30,000 g/mol to about 300,000 g/mol, as measured by GPC. In addition, the aromatic vinyl polymer may have an intrinsic viscosity (IV) from about 5 dL/g to about 100 dL/g, for example, from about 10 dL/g to about 50 dL/g, as measured at about 25° C. using an Ubbelohde viscometer after the polyarylene ether resin is dissolved in sulfuric acid (about 98%). Within these ranges of weight average molecular weight and intrinsic viscosity, the impact modifier can be easily dispersed and the resin composition can have excellent flame retardancy, impact strength and balance therebetween.

In one embodiment, the base resin may include the aromatic vinyl polymer in an amount of about 30 wt % to about 70 wt %, for example, about 40 wt % to about 60 wt %, based on the total weight (100 wt %) of the base resin including the polyarylene ether resin and the aromatic vinyl polymer. In some embodiments, the base resin may include the aromatic vinyl polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of aromatic vinyl polymer can be in a range from about any of the foregoing amounts to about any other of the foregoing amounts.

Within this range, the impact modifier can be easily dispersed and the resin composition can have excellent flame retardancy, impact strength and balance therebetween.

According to the present invention, the flame retardant may include a conventional flame retardant used in flame retardant thermoplastic resin compositions. For example, the flame retardant may include a phosphorus flame retardant. Examples of the phosphorous flame reactant may include without limitation red phosphorus, phosphates, phosphonates, phosphinates, phosphine oxides, phosphazenes, metallic salts thereof, and the like. The flame retardant may be a compound and/or a polymer, and may be a liquid. In addition, the flame retardants may be used alone or in combination thereof.

In one embodiment, the phosphorus retardant may include a compound represented by Formula 2:

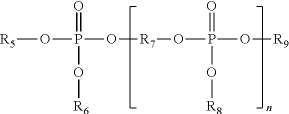

wherein R₅, R₆, R₈ and R₉ are the same or different and are each independently substituted or unsubstituted C6 to C20 aryl; R₇ is a derivative (moiety excluding a hydroxyl group) of a dialcohol of resorcinol, hydroquinone, bisphenol-A, or bisphenol-S; and n is an integer from 0 to 10. As used here, the substituent may be C₁ to C₁₀ alkyl and the like.

When n is 0 in Formula 2, examples of the compound may include without limitation triphenyl phosphate, tricresyl phosphate, cresyl diphenyl phosphate, trixylyl phosphate, tri(2,4,6-trimethylphenyl) phosphate, tri(2,4-di-tert-butylphenyl) phosphate, tri(2,6-di-tert-butylphenyl)phosphate, and the like. In addition, when n is 1 in Formula 2, examples of the compound may include without limitation resorcinol bis(diphenyl phosphate), hydroquinone bis(diphenyl phosphate), bisphenol-A bis(diphenyl phosphate), resorcinol bis(2,6-di-tert-butylphenyl phosphate), hydroquinone bis(2,6-dimethylphenyl phosphate), and the like. When n is 2 or more in Formula 2, the compound may be present in the form of an oligomer. Combinations of the foregoing compounds may also be present.

In one embodiment, the thermoplastic resin composition may include the flame retardant in an amount of about 5 parts by weight to about 30 parts by weight, for example, about 10 parts by weight to about 20 parts by weight, based on about 100 parts by weight of the base resin. In some embodiments, the thermoplastic resin composition may include the flame retardant in an amount of about 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of flame retardant can be in a range from about any of the foregoing amounts to about any other of the foregoing amounts.

Within this range, the resin composition can exhibit improved flame retardancy without deterioration of other properties.

According to the present invention, the impact modifier is dispersed as a spherical discontinuous phase (dispersed phase) in a continuous phase including the base resin and the flame retardant. The impact modifier may be a rubber-modified vinyl graft copolymer having a core-shell structure, in which an unsaturated monomer including about 95 wt % to about 99 wt % of an aromatic vinyl compound and about 1 wt % to about 5 wt % of a vinyl cyanide compound is grafted to a rubbery polymer.

Examples of the rubbery polymer may include without limitation diene rubbers, such as polybutadiene, poly(styrene-butadiene), poly(acrylonitrile-butadiene), and the like; saturated rubbers obtained by adding hydrogen to the diene rubbers; isoprene rubbers; acrylic rubbers such as polybutyl acrylate and the like; ethylene-propylene-diene monomer (EPDM), and the like, and combinations thereof For example, the rubbery polymer may be a diene rubber, for example a butadiene rubber.

In one embodiment, the rubber-modified vinyl graft copolymer may include the rubbery polymer in an amount of about 5 wt % to about 65 wt %, for example, about 10 wt % to about 60 wt %, based on the total weight (100 wt %) of the rubber-modified vinyl graft copolymer. In some embodiments, the rubber-modified vinyl graft copolymer may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt %. Further, according to some embodiments of the present invention, the amount of rubbery polymer can be in a range from about any of the foregoing amounts to about any other of the foregoing amounts.

Within this range, the resin composition can exhibit excellent impact strength.

In addition, the rubbery polymer (rubbery particles) may have an average (Z-average) particle size from about 0.05 μm to about 6 μm, for example, from about 0.15 μm to about 4 μm, and as another example from about 0.25 μm to about 3.5 μm. Within this range, the resin composition can exhibit excellent impact strength and appearance.

The aromatic vinyl compound may be an aromatic vinyl compound capable of being grafted to the rubbery copolymer. Examples of the aromatic vinyl compound capable of being grafted to the rubbery copolymer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and mixtures thereof. In exemplary embodiments, the aromatic vinyl compound may be styrene.

The unsaturated monomer may include the aromatic vinyl compound in an amount of about 95 wt % to about 99 wt %, for example, about 96 wt % to about 98 wt %, based on the total amount (100 wt %) of the unsaturated monomer. In some embodiments, the unsaturated monomer may include the aromatic vinyl compound in an amount of about 95, 96, 97, 98, or 99 wt %. Further, according to some embodiments of the present invention, the amount of aromatic vinyl compound can be in a range from about any of the foregoing amounts to about any other of the foregoing amounts.

If the amount of the aromatic vinyl compound is less than about 95 wt %, there is a concern that the resin composition may exhibit deteriorated impact strength, flame retardancy and the like due to deterioration in dispersibility of the impact modifier. If the amount of the aromatic vinyl compound is greater than about 99 wt %, there is a concern that the resin composition can have poor colorability.

The vinyl cyanide compound is a monomer copolymerizable with the aromatic vinyl compound. Examples of the monomer copolymerizable with the aromatic vinyl compound may include without limitation acrylonitrile, methacrylonitrile, ethacrylonitrile, and the like. These may be used alone or in combination thereof.

The unsaturated monomer may include the vinyl cyanide compound in an amount of about 1 wt % to about 5 wt %, for example, about 2 wt % to about 4 wt %, based on the total amount (100 wt %) of the unsaturated monomer. In some embodiments, the unsaturated monomer may include the vinyl cyanide compound in an amount of about 1, 2, 3, 4, or 5 wt %. Further, according to some embodiments of the present invention, the amount of vinyl cyanide compound can be in a range from about any of the foregoing amounts to about any other of the foregoing amounts.

If the amount of the vinyl cyanide compound is less than about 1 wt %, there is a concern that the resin composition can suffer from peeling or milky marks upon injection molding due to insufficient binding strength of the vinyl cyanide compound to the resin. If the amount of the vinyl cyanide compound is greater than about 5 wt %, there is a concern that the resin composition can exhibit deteriorated impact strength, flame retardancy and the like due to deterioration in dispersibility of the impact modifier.

In one embodiment, the rubber-modified vinyl graft copolymer can include the unsaturated monomer in an amount of about 35 wt % to about 95 wt %, for example, about 40 wt % to about 90 wt %, based on the total weight (100 wt %) of the rubber-modified vinyl graft copolymer. In some embodiments, the rubber-modified vinyl graft copolymer may include the unsaturated monomer in an amount of about 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of unsaturated monomer can be in a range from about any of the foregoing amounts to about any other of the foregoing amounts.

Within this range, the resin composition can exhibit excellent impact strength.

Examples of the rubber-modified vinyl graft copolymer may include a copolymer (g-ABS) in which a styrene monomer corresponding to the aromatic vinyl compound and an acrylonitrile monomer corresponding to the vinyl cyanide compound are grafted to a core butadiene rubbery polymer to form a shell, without being limited thereto.

In one embodiment, the resin composition may include the impact modifier in an amount of about 12 parts by weight to about 18 parts by weight, for example, about 14 parts by weight to about 16 parts by weight, based on about 100 parts by weight of the base resin. In some embodiments, the resin composition may include the impact modifier in an amount of about 12, 13, 14, 15, 16, 17, or 18 parts by weight. Further, according to some embodiments of the present invention, the amount of impact modifier can be in a range from about any of the foregoing amounts to about any other of the foregoing amounts.

Within this range, the impact modifier can be easily dispersed and the resin composition can have excellent flame retardancy, impact strength and balance therebetween.

The impact modifier forms a spherical dispersed phase and the dispersed phase may have the same average diameter as that of the impact modifier. For example, the impact modifier may have an average diameter from about 0.1 μm to about 6 μm, without being limited thereto. Since the impact modifier can exhibit excellent dispersibility, the impact modifier can provide excellent impact strength to the resin composition without deterioration in flame retardancy, even when used in a smaller amount than general impact modifiers.

According to the present invention, the thermoplastic resin composition may further include one or more conventional additives, as needed. Examples of the additives may include without limitation antioxidants, lubricants, nucleating agents, surfactants, coupling agents, fillers, plasticizers, antimicrobials, release agents, heat stabilizers, photostabilizers, compatibilizers, inorganic additives, colorants, stabilizers, antistatic agents, pigments, dyes, flame proofing agents, and the like. These may be used alone or in combination thereof.

The additives may be present in an amount of about 0.01 parts by weight to about 40 parts by weight based on about 100 parts by weight of the thermoplastic resin, without being limited thereto.

In one embodiment, the thermoplastic resin composition may have an Izod impact strength from about 7 kgf·cm/cm to about 20 kgf·cm/cm, for example, from about 8 kgf·cm/cm to about 13 kgf·cm/cm, as measured on an about ⅛″ thick specimen in accordance with ASTM D638.

In one embodiment, the thermoplastic resin composition may have a flame retardancy level of V0 or higher, as measured on an about 2.5 mm thick specimen according to the UL-94 vertical flammability test method.

In accordance with another aspect of the present invention, a molded article is formed of the above thermoplastic resin composition. The thermoplastic resin composition according to the present invention may be prepared by a method of preparing a thermoplastic resin composition known in the art. For example, the above components and, optionally, one or more other additives can be mixed, followed by melt extrusion in an extruder, thereby preparing a resin composition in the form of pellets. The prepared pellets may be produced into various molded articles (products) through various molding methods, such as injection molding, extrusion, vacuum molding, casting, and the like. Such molding methods are well known to those skilled in the art. Since the molded article can exhibit excellent properties in terms of flame retardancy, impact resistance, fluidity and the like, the molded article is useful for automotive components, electronic components, exterior materials and the like, which require these properties.

Hereinafter, the present invention will be described in more detail with reference to the following examples. It should be understood that these examples are provided for illustration only and are not to be construed in any way as limiting the present invention.

### EXAMPLES

Details of components used in the following Examples and Comparative Examples are as follows:

(A) Polyarylene ether resin: A polyphenylene ether (PPE) resin (LXR-035C, Blue Star Co., Ltd., weight average molecular weight (Mw): 30,000 g/mol, intrinsic viscosity (IV): 38 dL/g to 41 dL/g) is used.

(B) Aromatic vinyl polymer: A polystyrene (PS) resin (TAIRIREX GP-5000, Formosa Co., Ltd., weight average molecular weight (Mw): 33,000 g/mol, intrinsic viscosity (IV): 40 dL/g) is used.

(C) Flame retardant: Bisphenol-A bis(diphenyl phosphate) (BDP) is used.

(D) Impact Modifier

(D1) g-ABS 1: An acrylonitrile-butadiene-styrene graft copolymer (g-ABS), in which 44 wt % of an unsaturated monomer (97 wt % of a styrene monomer and 3 wt % of an acrylonitrile monomer) is grafted to 56 wt % of polybutadiene latex (PBL) having an average particle size of 310 nm, is used.

(D2) g-ABS 2: An acrylonitrile-butadiene-styrene graft copolymer (g-ABS), in which 50 wt % of an unsaturated monomer (83 wt % of a styrene monomer and 17 wt % of an acrylonitrile monomer) is grafted to 50 wt % of polybutadiene latex (PBL) having an average particle size of 250 nm, is used.

(D3) g-ABS 3: An acrylonitrile-butadiene-styrene graft copolymer (g-ABS), in which 44 wt % of an unsaturated monomer (75 wt % of a styrene monomer and 25 wt % of an acrylonitrile monomer) is grafted to 56 wt % of polybutadiene latex (PBL) having an average particle size of 310 nm, is used.

### Example 1 and Comparative Examples 1 to 2

The components are added in amounts as listed in Table 1, followed by melting, kneading and extrusion, thereby preparing pellets. Here, extrusion is performed using a twin-screw extruder having L/D of 32 and a diameter of 45 mm, and a flame retardant is added by side feeding. The prepared pellets are dried at 80° C. for 6 hours, followed by injection molding using a 3 oz injection machine at 270° C., thereby preparing a specimen (4 mm×4 mm×2.5 mm) The prepared specimen is evaluated as to the following properties. Results are shown in Table 1.

Evaluation of Properties

(1) Izod impact strength (unit: kgf·cm/cm): Izod impact strength is measured on a ⅛″ thick notched Izod specimen in accordance with ASTM D256.

(2) Flame retardancy: Flame retardancy of the above specimen is measured according to the UL-94 vertical flammability test method.

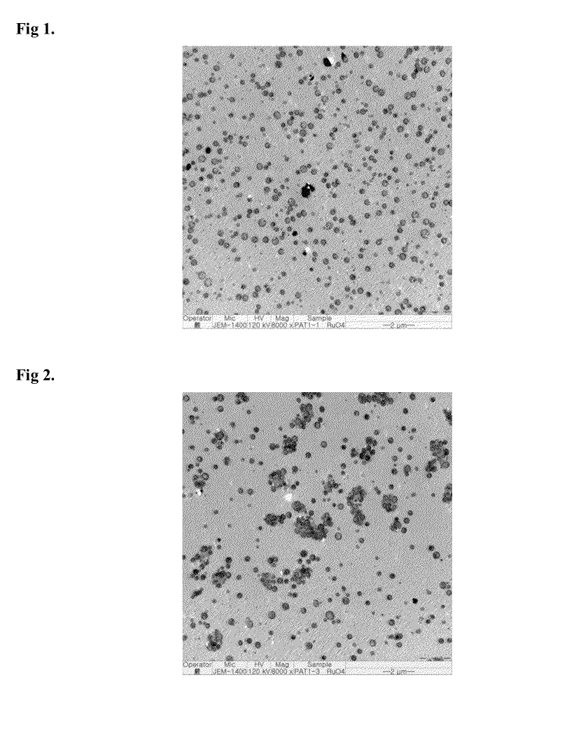

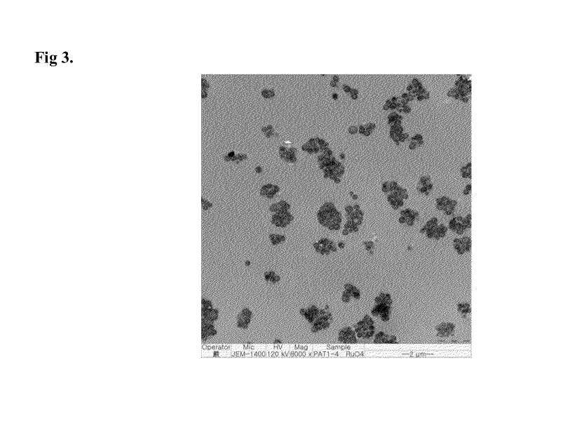

(3) Dispersibility: A transmission electron microscope (TEM) (TF30, FEI Co., Ltd., magnification: 30 K) image of the specimen is photographed to observe dispersibility of an impact modifier. A TEM image of the specimen of Example 1 is shown in FIG. 1, and TEM images of the specimens of Comparative Examples 1 and 2 are shown in FIGS. 2 and 3, respectively.

TABLE 1

| | | Comparative | Comparative |
|---|---|---|---|
| Item | Example 1 | Example 1 | Example 2 |
| (A) (wt %) | 53 | 53 | 53 |
| (B) (wt %) | 47 | 47 | 47 |
| (C) (parts by weight) | 20 | 20 | 20 |
| (D1) (parts by weight) | 15.8 | — | — |
| (D2) (parts by weight) | — | 15.8 | — |
| (D3) (parts by weight) | — | — | 15.8 |
| Izod impact strength | 9.5 | 5.1 | 4.6 |
| (kgf · cm/cm) | | | |
| Flame retardancy level | V0 | V0 | V0 |

*Parts by weight: parts by weight based on 100 parts by weight of base resin (A + B)

From the results of Table 1, it can be seen that the thermoplastic resin composition (Example 1) according to the present invention including the impact modifier ((D1) g-ABS), in which the amount of the unsaturated monomer is adjusted, exhibits excellent impact strength and flame retardancy even though the impact modifier is used in a small amount of 18 parts by weight or less. The reason being that, since the impact modifier is uniformly dispersed (see FIG. 1), excellent impact strength could be imparted to the overall resin composition despite the small amount of the impact modifier.

Conversely, it can be seen that the resin compositions of Comparative Examples 1 and 2 using the conventional impact modifiers, in which the amount of the unsaturated monomer is outside the range according to the present invention, include the impact modifiers not uniformly dispersed therein (see FIGS. 2 and 3), and suffer from deterioration in impact strength, flame retardancy, and the like.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A thermoplastic resin composition comprising:
a base resin comprising a polyarylene ether resin and an aromatic vinyl polymer;
a flame retardant; and
an impact modifier,
wherein the impact modifier is a rubber-modified vinyl graft copolymer in which an unsaturated monomer comprising about 95 wt % to about 99 wt % of an aromatic vinyl compound and about 1 wt % to about 5 wt % of a vinyl cyanide compound is grafted to a rubbery polymer, the base resin and the flame retardant form a continuous phase, and the impact modifier forms a dispersed phase.

2. The thermoplastic resin composition according to claim 1, wherein the base resin comprises about 30 wt % to about 70 wt % of the polyarylene ether resin and about 30 wt % to about 70 wt % of the aromatic vinyl polymer.

3. The thermoplastic resin composition according to claim 1, comprising the flame retardant in an amount of about 5 parts by weight to about 30 parts by weight, and the impact modifier in an amount of about 12 parts by weight to about 18 parts by weight, each based on about 100 parts by weight of the base resin.

4. The thermoplastic resin composition according to claim 1, wherein the polyarylene ether resin is a polymer comprising a repeat unit represented by Formula 1: 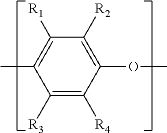
wherein R₁, R₂, R₃ and R₄ are the same or different and are each independently a hydrogen atom, a halogen atom, C₁ to C₆ alkyl, or C₆ to C₁₂ aryl.

5. The thermoplastic resin composition according to claim 1, wherein the aromatic vinyl polymer comprises at least one of polystyrene, poly(α-methylstyrene), poly(β-methylstyrene), and polyvinyl naphthalene.

6. The thermoplastic resin composition according to claim 1, wherein the polyarylene ether resin has a weight average molecular weight from about 10,000 g/mol to about 200,000 g/mol, and the aromatic vinyl polymer has a weight average molecular weight from about 20,000 g/mol to about 500,000 g/mol.

7. The thermoplastic resin composition according to claim 1, wherein the thermoplastic resin composition has an Izod impact strength from about 7 kgf·cm/cm to about 20 kgf·cm/cm, as measured on an about ⅛″ thick specimen in accordance with ASTM D638.

8. The thermoplastic resin composition according to claim 1, wherein the thermoplastic resin composition has a flame retardancy level of V0 or higher, as measured on an about 2.5 mm thick specimen according to the UL-94 vertical flammability test method.

9. A molded article formed of the thermoplastic resin composition according to claim 1.
